(19) United States
(12) Patent Application Publication
(10) Pub. No.: US 2017/0276695 A1
(43) Pub. Date: Sep. 28, 2017

(54) SENSOR-BEARING UNIT, MECHANICAL SYSTEM COMPRISING SUCH UNIT AND METHOD FOR MANUFACTURING SUCH UNIT

(71) Applicant: Aktiebolaget SKF, Goteborg (SE)

(72) Inventor: Mathieu Hubert, Ann Arbor, MI (US)

(21) Appl. No.: 15/506,129

(22) PCT Filed: Aug. 29, 2014
(86) PCT No.: PCT/EP2014/068436

§ 371 Date: Feb. 23, 2017

(51) Int. Cl. G01P 3/487; G01D 5/244; G01D 5/245; G01P 3/488

(52) U.S. Cl. CPC G01P 3/487; G01P 3/488; G01D 5/24438; G01D 5/2451

(57) ABSTRACT

A sensor-bearing unit providing: a bearing centered on a rotation axis; a sensor device including a differential detection cell that has a structural pitch and defines a pitch plane extending along the structural pitch and along a reading direction; and an impulse ring having a magnetic pattern that includes positive poles and negative poles separated by pattern borders and which defines a tangent plane perpendicular to the pitch plane. The sensor device and the impulse ring are configured for tracking a rotation of the bearing around the rotation axis, the differential detection cell of the sensor device reading the magnetic pattern of the impulse ring along the reading direction. Each pattern border defines a nonzero pattern angle relative to the pitch plane. The invention also concerns a mechanical system with such an impulse ring. The invention also concerns a method for manufacturing such an impulse ring.

### FIELD OF THE INVENTION

The invention concerns a sensor-bearing unit comprising a bearing, a sensor device and an impulse ring for tracking a rotation of the bearing. The invention also concerns a mechanical system, for example a motorcycle axle, comprising at least one such sensor-bearing unit. The invention also concerns a method for manufacturing such a sensor-bearing unit.

### BACKGROUND OF THE INVENTION

Sensor-bearing units are commonly used in automotive, aeronautics and other technical fields. These units provide high quality signals and transmissions, while allowing integration in simpler and more compact mechanical systems.

Such a sensor-bearing unit generally provides a bearing, an impulse ring and a sensor device facing the impulse ring. The impulse ring may be fixed to a rotating ring of the bearing, while the sensor device may be fixed to a non-rotating ring of the bearing or to another part supporting this non-rotating ring. The impulse ring may provide a target holder and a target including alternating north and south poles, whose number depends on bearing size and particular application. The sensor device may provide a differential hall cell including two sensing elements.

For certain applications, by example wheel speed measurement, a differential sensor device allows to reduce noise and increase amplitude of the electric signal inside the sensor device by a subtraction of the two measurements. To obtain the maximum efficiency of this effect, the pitch between the two sensitive elements and the pitch of the magnetic ring should be compatible, i.e. be equal for this application. Otherwise, the designer of the sensor-bearing unit may change the hall cell for a more compatible one or modify the size of the impulse ring. However, those methods decrease the flexibility of the design. Moreover, changing the hall cell is not always possible.

For other applications, by example incremental encoders, a differential sensor device is used to create two signals with a phase shift of 90 degrees. The pitch between the two sensitive elements cannot be changed without a new sensor design, otherwise the phase shift between the two signals would not be equal to 90 degrees. The sensor designer has no flexibility concerning pitch of the impulse ring, which has to be designed in parallel to the hall cell.

BRIEF SUMMARY OF THE INVENTION

The aim of the invention is to provide a sensor-bearing unit having an impulse ring with improved flexibility.

To this end, the invention concerns a sensor-bearing unit, comprising: a bearing centered on a rotation axis; a sensor device including a differential detection cell which has a structural pitch and which defines a pitch plane extending along the structural pitch and along a reading direction; and an impulse ring having a magnetic pattern which includes positive poles and negative poles separated by pattern borders and which defines a tangent plane perpendicular to the pitch plane; the sensor device and the impulse ring being configured for tracking a rotation of the bearing around the rotation axis, the differential detection cell of the sensor device reading the magnetic pattern of the impulse ring along the reading direction. According to the invention, each pattern border projected in the tangent plane defines a nonzero pattern angle relative to the pitch plane.

Thanks to the invention, the design of the impulse ring has an important flexibility. Besides, a modification of the sensor design is not mandatory if the design of the impulse ring is fixed. Since the differential effect of the sensor device can be correctly used, the magnetic field necessary for the impulse ring can be reduced, despite the impulse ring having smaller poles than the sensor pitch. This effect has several positive impacts on the design of the sensor device. The distance between the sensor device and the impulse ring can be increased, so that the sensor-bearing unit can be designed with more flexibility. Moreover, the material of the impulse ring can have a lower remnant induction, so that the cost of the impulse ring can be reduced. Finally, the process to magnetize each pole pairs with a specific pattern angle induces no additional cost in comparison with a standard magnetic impulse ring.

According to further aspects of the invention which are advantageous but not compulsory, such a sensor-bearing unit may incorporate one or several of the following features:
The impulse ring is configured as a radial impulse ring for radial reading by the sensor device.
The pattern angle is constant along the rotation axis for each pattern border.
The pattern angle is variable along the rotation axis for each pattern border.
The impulse ring is configured as an axial impulse ring for axial reading by the sensor device.
The pattern angle is constant away from the rotation axis for each pattern border.
The pattern angle is variable away from the rotation axis for each pattern border.

The invention also concerns a mechanical system, for example a motorcycle axle, comprising at least one sensor-bearing unit as mentioned here-above. The invention may be implemented within different mechanical systems, for instance crankshafts, camshafts, wheel hubs for cars or for commercial vehicles, etc.

The invention also concerns a method for manufacturing a sensor-bearing unit as mentioned here-above. The method provides at least a step of magnetizing the magnetic pattern of the impulse ring, such that each pattern border defines a nonzero pattern angle relative to the pitch plane.

Besides, such method may incorporate one or several of the following features:
The method provides a step of calculating the pattern angle for determining the shape of the pattern borders.
The method provides a step of simulating the magnetic pattern of the impulse ring with a finite element analysis software.

### BRIEF DESCRIPTION OF THE SEVERAL VIEWS OF THE DRAWING

The invention will now be explained in correspondence with the annexed figures, and as an illustrative example, without restricting the object of the invention. In the annexed figures:

FIG. 1 is a radial view of a sensor-bearing unit, not configured according to the invention, including a radial impulse ring and a standard differential sensor device, wherein the configuration of the impulse ring and the sensor device is ideal since the ring pitch is equal to the sensor pitch;

FIG. 2 is a view similar to FIG. 1, showing another sensor-bearing unit not configured according to the invention, wherein the configuration of the impulse ring and the sensor device is not favorable since the ring pitch is not equal to the sensor pitch;

FIG. 3 is a view similar to FIG. 1, showing a sensor-bearing unit and a radial impulse ring according to a first embodiment of the invention;

FIG. 4 is a view similar to FIG. 1, showing a sensor-bearing unit and a radial impulse ring according to a second embodiment of the invention;

FIG. 5 is an axial view of a sensor-bearing unit and an axial impulse ring according to a third embodiment of the invention;

FIG. 6 is a view at a larger scale of detail VI on FIG. 5; and

FIG. 7 is an axial view of a sensor-bearing unit and an axial impulse ring according to a fourth embodiment of the invention.

### DETAILED DESCRIPTION OF THE INVENTION

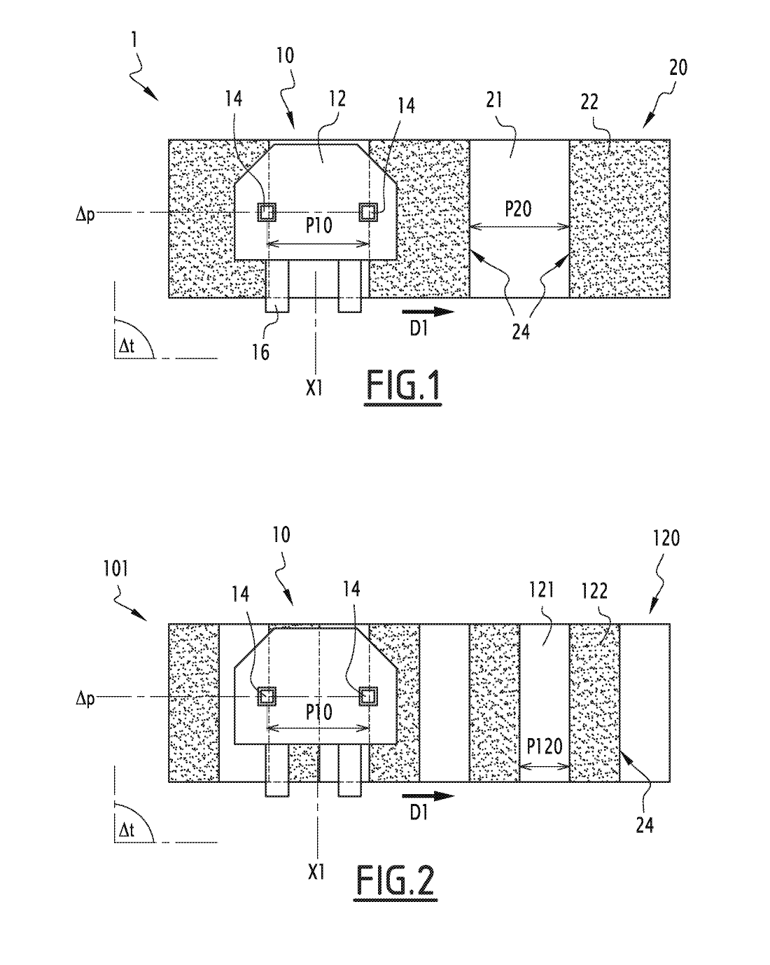

FIG. 1 shows a sensor-bearing unit 1, comprising a bearing, a sensor device 10 and an impulse ring 20. The bearing, not shown for simplification purpose, is centered on a central axis X1. The sensor device 10 and the impulse ring 20 are associated for tracking the rotation of the bearing around this axis X1. The impulse ring 20 may be fixed to a rotating ring of the bearing, while the sensor device 10 may be fixed to a non-rotating ring of the bearing or to another part supporting this non-rotating ring.

The sensor device 10 is configured as a standard differential sensor, comprising a body 12, a differential detection cell provided with two sensitive detection components 14, and two legs 16. Components 14 define a sensor pitch P10 of the differential detection cell, that is a length measured between their centers along a direction D1. For instance, pitch P10 may be equal to 2 millimeters. Components 14 also define a pitch plane Δp extending along the structural pitch P10 and along a reading direction. Components 14 provide two signals, corresponding to continuous measurements separated spatially by pitch P10. The legs 16, partially shown, extend up to a control system for processing those signals.

The impulse ring 20 is configured as a standard radial magnetic ring, centered on axis X1. The impulse ring 20 has a magnetic pattern, including positive poles 21 and negative poles 22 separated by pattern borders 24. Since impulse ring 20 is configured as a radial ring, the magnetic pattern is formed at its outer surface around axis X1. A tangent plane Δt is defined as being tangent to this outer surface, perpendicular to pitch plane Δp and orthoradial to axis X1. Impulse ring 20 is shown partially, with its outer surface projected in tangent plane Δt, for simplification purpose. Between two successive borders 24, each pole 21 and 22 has a ring pitch P20 which is also is defined parallel to direction D1. Pitch P20 corresponds to the width of each pole 21 and 22 along direction D1. In the present case, direction D1 is orthoradial to the rotation axis X1 of the impulse ring 20. Borders 24 are parallel to each other and perpendicular to direction D1.

In practice, the differential detection cell of sensor device 10 reads the magnetic pattern of impulse ring 20 along the reading direction, which is radial to axis X1. Sensor device 10 detects magnetic field variations induced by impulse ring 20. More precisely, detection components 14 detect magnetic field variations induced by borders 24 separating positive poles 21 and negative poles 22. The accuracy of rotation speed, rotation angle and other data measured by sensor-bearing unit 1 are highly related to the accuracy of the mounting of sensor device 10 and impulse ring 20.

In this regard, sensor device 10 and impulse ring 20 are positioned such that pitches P10 and P20 are both parallel to direction D1 and that a plane which includes axis X1 and is perpendicular to both planes Δp and Δt constitutes a plane of symmetry for components 14. Moreover, sensor device 10 and impulse ring 20 are designed such that pitches P10 and P20 are compatible, i.e. they preferably have the same value, or they have values with a difference which is as low as possible.

Inside the control system of sensor-bearing unit 1, the two signals measured by detection components 14 are subtracted and the obtained signal is used by the control system to acquire the speed signal. For instance, the control system may provide a trigger with a threshold of +/−20G for the differential signal, which means in the best cases a minimum magnetic field of +/−10G measured by each detection components 14. However, if pitches P10 and P20 have different values, the magnetic field necessary to obtain at least +/−20G for the differential signal will be more than +/−10G for each detection components 14. This phenomenon implies the need of an increased magnetic field, by reducing the distance between sensor device 10 and impulse ring 20 in pitch plane Δp, or by changing the magnetic material of the impulse ring 20. Those two solutions are sometimes not available due to design or process reasons.

FIGS. 2 to 7 show other sensor-bearing units, with elements similar to FIG. 1 having the same numerical references. Elements which are different from FIG. 1 have numerical references increased by 100, 200, 300, 400 or 500.

FIG. 2 shows a sensor-bearing unit 101, comprising a bearing not shown, the sensor device 10 and an impulse ring 120. Sensor device 10 is still configured as a standard differential sensor. Impulse ring 120 is configured as a radial magnetic ring which is not compatible with sensor device 10. Impulse ring 120 has a magnetic pattern, including positive poles 121 and negative poles 122 separated by pattern borders 124. Impulse ring 120 has a pitch P120 corresponding to half of pitch P10. In this case, whatever the amplitude of the magnetic field, the differential signal is close to zero. Consequently, sensor-bearing unit 101 will not work correctly for tracking the rotation of the bearing.

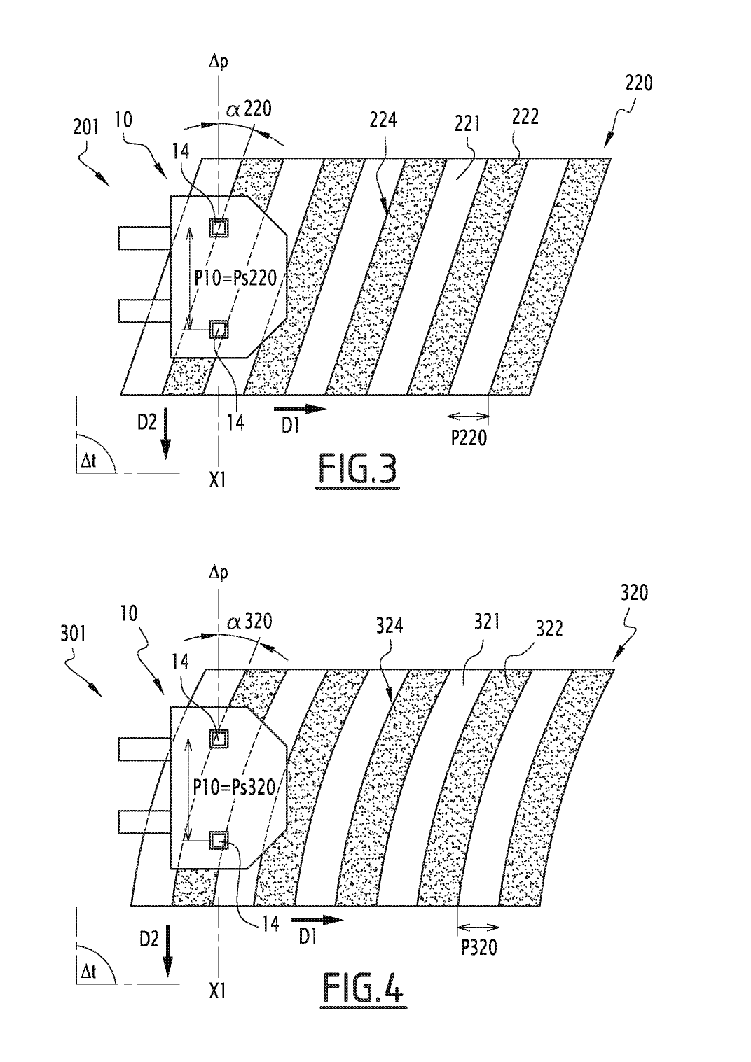

FIG. 3 shows a sensor-bearing unit 201, according to a first embodiment of the invention. Sensor-bearing unit 201 provides a bearing not shown, the sensor device 10 and an impulse ring 220. Sensor device 10 is still configured as a standard differential sensor. Sensor device 10 is positioned relative to impulse ring 220 in a way such that pitch plane Δp includes axis X1 and that pitch P10 is defined in pitch plane Δp along a direction D2 which is parallel to axis X1.

Impulse ring 220 is configured as a radial magnetic ring, adapted for radial reading by sensor device 10. Impulse ring 220 has a magnetic pattern, including positive poles 221 and negative poles 222 separated by pattern borders 224. In the present case, borders 224 projected in tangent plane Δt are inclined of a pattern angle α220 relative to pitch plane Δp. For each border 224, the pattern angle α220 is constant along axis X1.

Impulse ring 220 defines a structural pitch P220 along direction D1, which is orthoradial to axis X1, orthogonal to pitch plane Δp and parallel to tangent plane Δt. In the present case, pitches P10 and P220 are not compatible. Since the borders 224 projected in tangent plane Δt are inclined relative to pitch plane Δp, impulse ring 220 further defines an apparent pitch or shifted pitch Ps220 along direction D2 in pitch plane Δp. Pitch Ps220 has a constant value, whatever the reading diameter chosen on the impulse ring 220. Impulse ring 220 is designed, then sensor device 10 and impulse ring 220 are positioned relative to each other, such that pitches P10 and Ps220 are compatible, and preferably have the same value. Thus, sensor-bearing unit 201 can work correctly for tracking the rotation of the bearing.

FIG. 4 shows a sensor-bearing unit 301, according to a second embodiment of the invention. Sensor-bearing unit 301 provides a bearing not shown, the sensor device 10 and an impulse ring 320. Sensor device 10 is still configured as a standard differential sensor. Sensor device 10 is positioned relative to impulse ring 320 in a way such that pitch plane Δp includes axis X1 and that pitch P10 is defined along direction D2.

Impulse ring 320 is configured as a radial magnetic ring. Impulse ring 320 has a magnetic pattern, including positive poles 321 and negative poles 322 separated by pattern borders 324. In the present case, borders 324 projected in tangent plane Δt are inclined of a variable pattern angle α320 relative to pitch plane Δp. For each border 324, the pattern angle α320 is variable along axis X1, depending on the reading diameter. In other words, the borders 324 are curved.

Impulse ring 320 defines a structural pitch P320 along direction D1. In the present case, pitches P10 and P320 are not compatible. Since the borders 324 projected in tangent plane Δt are inclined relative to pitch plane Δp, impulse ring 320 further defines a shifted pitch Ps320 along direction D2 in pitch plane Δp. Pitch Ps320 has a variable value, depending on the reading diameter chosen on the impulse ring 320. Impulse ring 320 is designed, then sensor device 10 and impulse ring 320 are positioned relative to each other, such that pitches P10 and Ps320 are compatible, and preferably have the same value. Thus, sensor-bearing unit 301 can work correctly for tracking the rotation of the bearing.

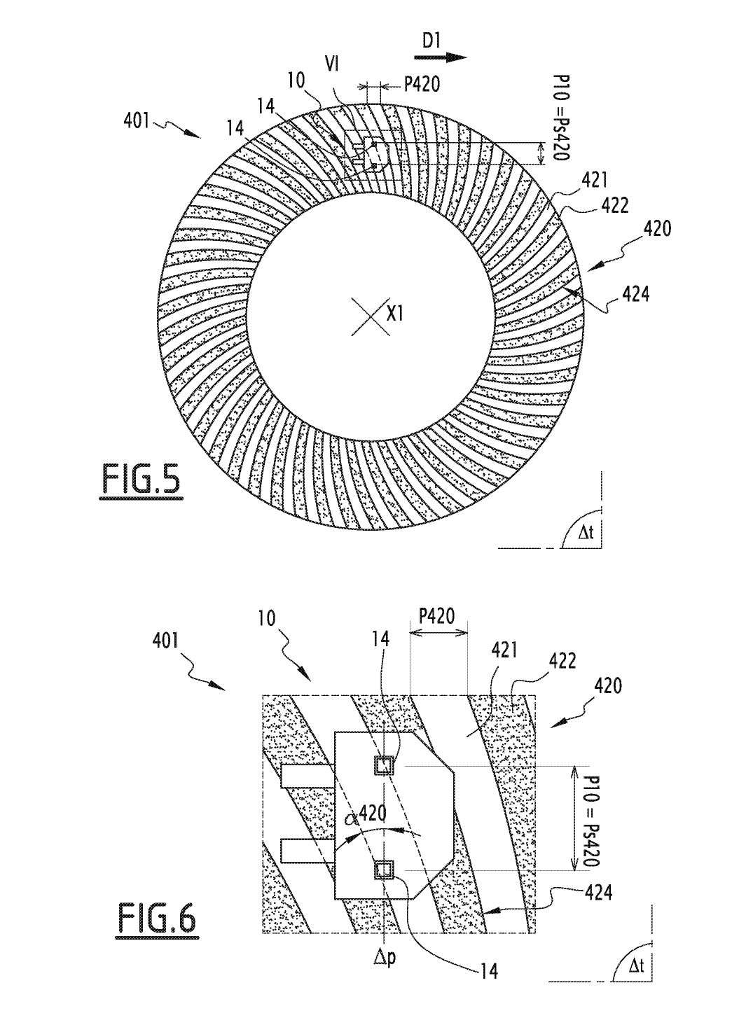

FIGS. 5 and 6 show a sensor-bearing unit 401, according to a third embodiment of the invention. Sensor-bearing unit 401 provides a bearing not shown, the sensor device 10 and an impulse ring 420. Sensor device 10 is still configured as a standard differential sensor. Sensor device 10 is positioned relative to impulse ring 420 in a way such that pitch plane Δp includes axis X1 and that pitch P10 is defined in pitch plane Δp along a direction D1, which is orthoradial to axis X1.

Impulse ring 420 is configured as an axial magnetic ring, adapted for axial reading by sensor device 10. The reading direction is parallel to axis X1. Impulse ring 420 has a magnetized pattern, including positive poles 421 and negative poles 422 separated by pattern borders 424. Since impulse ring 420 is configured as an axial ring, the magnetic pattern is formed on its outer surface in a tangent plane Δt which is perpendicular to axis X1. In the present case, borders 424 projected in tangent plane Δt are inclined of a variable pattern angle α420 relative to pitch plane Δp. For each border 424, the pattern angle α420 is variable away from axis X1, depending on the reading diameter. In other words, the borders 424 are curved. More precisely, the borders 424 form curved radius distributed around axis X1. Impulse ring 420 has a skewed magnetic pattern.

Impulse ring 420 defines a variable structural pitch P420 along direction D1. In the present case, pitches P10 and P420 are not compatible. Since the borders 424 projected in tangent plane Δt are inclined relative to pitch plane Δp, impulse ring 420 further defines a shifted pitch Ps420 along direction D1 in pitch plane Δp. Pitch Ps420 has a variable value, depending on the reading diameter chosen on the impulse ring 420. Impulse ring 420 is designed, then sensor device 10 and impulse ring 420 are positioned relative to each other, such that pitches P10 and Ps420 are compatible, and preferably have the same value. Thus, sensor-bearing unit 401 can work correctly for tracking the rotation of the bearing.

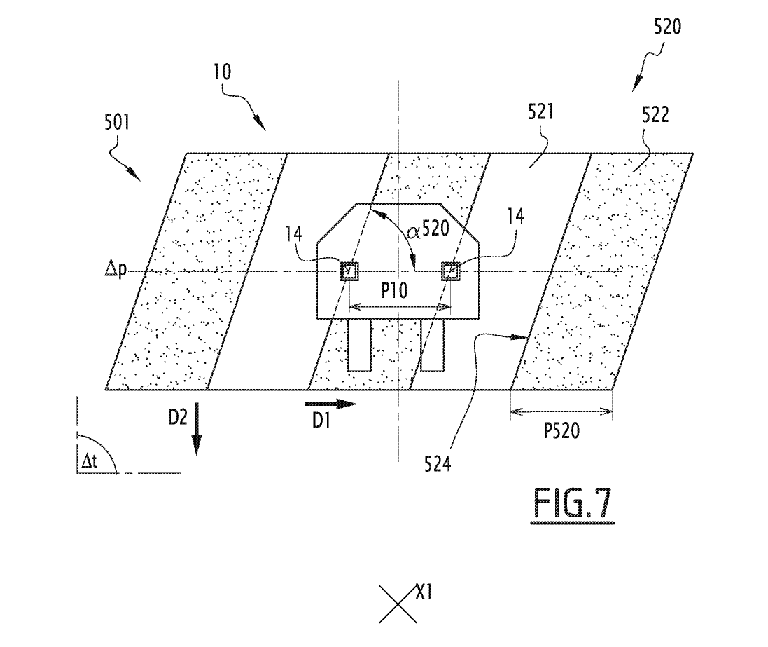

FIG. 7 shows a sensor-bearing unit 501, according to a fourth embodiment of the invention. Sensor-bearing unit 501 provides a bearing not shown, the sensor device 10 and an impulse ring 520. Sensor device 10 is still configured as a standard differential sensor. Sensor device 10 is positioned relative to impulse ring 520 in a way such that pitch plane Δp is parallel to axis X1 and that pitch P10 is defined in pitch plane Δp along a direction D1, which is orthoradial to axis X1.

Impulse ring 520 is configured as an axial magnetic ring, adapted for axial reading by sensor device 10. Impulse ring 520 is curved around axis X1, but is represented has a straight band for simplification purpose. Impulse ring 520 has a magnetized pattern, including positive poles 521 and negative poles 522 separated by pattern borders 524. In the present case, borders 524 projected in tangent plane Δt are inclined of a variable pattern angle α520 relative to pitch plane Δp. For each border 524, the pattern angle α520 is constant away from axis X1. In other words, the borders 524 are straight.

Impulse ring 520 defines a structural pitch P520 along direction D1. Impulse ring 520 is designed, then sensor device 10 and impulse ring 520 are positioned relative to each other, such that pitches P10 and P520 are compatible, and preferably have the same value. Thus, sensor-bearing unit 501 can work correctly for tracking the rotation of the bearing.

A method for manufacturing an impulse ring 220, 320, 420, 520 is described here-after.

The method provides at least a step of magnetizing the magnetic pattern of the impulse ring 220, 320, 420, 520 such that each pattern border 224, 324, 424, 524 projected in tangent plane Δt defines a nonzero pattern angle α220, α320, α420, α520 relative to pitch plane Δp. Preferably, before the magnetization step, the method also provides a step of calculating the pattern angle α220, α320, α420, α520, thus determining the shape of each pattern border 224, 324, 424, 524 and the shifted pitch Ps220, Ps320, Ps420. Besides, the method can provide a step of simulating the magnetic pattern of the impulse ring 220, 320, 420, 520 with a finite elements analysis software.

In the example of FIG. 3 related to a radial magnetic target, pattern angle α220 is calculated as follows [Equation 1]:

α220=arctan (size of one pole 21 or 22 on a specific reading diameter/P10)=arctan ((reading diameter×Pi/number of poles)/P10)

In the example of FIG. 5 related to an axial magnetic target, pattern angle α420 is deduced by a method calculating the magnetization pattern in each position as follows [Equation 2]:

Magnetization pattern for a diameter of a given calculated position=Amplitude of the magnetic field×sin (size of one pole×2×angular position−(diameter of calculated position×Pi)/(sensor pitch P10×2))

wherein the Amplitude is the normal amplitude of the magnetic field.

Other non-shown embodiments can be implemented within the scope of the invention. For instance, the sensor device 10 may include a Hall plate. Alternately, the sensor device 10 may include a GMR, AMR or TMR bridge.

In addition, technical features of the different embodiments can be, in whole or part, combined with each other. Thus, the impulse ring and the sensor-bearing unit can be adapted to specific requirements of the application.

1. A sensor-bearing unit, comprising:
a bearing centered on a rotation axis;
a sensor device including a differential detection cell which has a structural pitch and which defines a pitch plane extending along the structural pitch and along a reading direction;
an impulse ring having a magnetic pattern which includes positive poles and negative poles separated by pattern borders and which defines a tangent plane perpendicular to the pitch plane;
the sensor device and the impulse ring being configured for tracking a rotation of the bearing around the rotation axis, the differential detection cell of the sensor device reading the magnetic pattern of the impulse ring along the reading direction; wherein
each pattern border projected in the tangent plane defines a nonzero pattern angle relative to the pitch plane.

2. The sensor-bearing unit according to claim 1, wherein the impulse ring is configured as a radial impulse ring for radial reading by the sensor device.

3. The sensor-bearing unit according to claim 2, wherein the pattern angle is constant along the rotation axis for each pattern border.

4. The sensor-bearing unit according to claim 2, wherein the pattern angle is variable along the rotation axis for each pattern border.

5. The sensor-bearing unit according to claim 1, wherein the impulse ring is configured as an axial impulse ring for axial reading by the sensor device.

6. The sensor-bearing unit according to claim 5, wherein the pattern angle is constant away from the rotation axis for each pattern border.

7. The sensor-bearing unit according to claim 5, wherein the pattern angle is variable away from the rotation axis for each pattern border.

8. A mechanical system, for example a motorcycle axle, comprising at least one sensor-bearing unit having a bearing centered on a rotation axis; a sensor device including a differential detection cell which has a structural pitch and which defines a pitch plane extending along the structural pitch and along a reading direction; an impulse ring having a magnetic pattern which includes positive poles and negative poles separated by pattern borders and which defines a tangent plane perpendicular to the pitch plane; the sensor device and the impulse ring being configured for tracking a rotation of the bearing around the rotation axis, the differential detection cell of the sensor device reading the magnetic pattern of the impulse ring along the reading direction; wherein
each pattern border projected in the tangent plane defines a nonzero pattern angle relative to the pitch plane.

9. A method for manufacturing a sensor-bearing unit having a bearing centered on a rotation axis; a sensor device including a differential detection cell which has a structural pitch and which defines a pitch plane extending along the structural pitch and along a reading direction; an impulse ring having a magnetic pattern which includes positive poles and negative poles separated by pattern borders and which defines a tangent plane-perpendicular to the pitch plane; the sensor device and the impulse ring being configured for tracking a rotation of the bearing around the rotation axis, the differential detection cell of the sensor device reading the magnetic pattern of the impulse ring along the reading direction; wherein
each pattern border projected in the tangent plane defines a nonzero pattern angle relative to the pitch plane.
wherein the method comprises at least a step of magnetizing the magnetic pattern of the impulse ring, such that each pattern border projected in the tangent plane defines a nonzero pattern angle relative to the pitch plane.

10. The method according to claim 9, further comprising a step of calculating the pattern angle for determining the shape of the pattern borders (224; 324; 424; 524).

11. The method according to claim 9, further comprising a step of simulating the magnetic pattern of the impulse ring with a finite element analysis software.
